(19) United States
(12) Patent Application Publication
(10) Pub. No.: US 2026/0031047 A1
(43) Pub. Date: Jan. 29, 2026

(54) PIXEL CIRCUIT, DISPLAY SUBSTRATE, DISPLAY DEVICE, AND DISPLAY DRIVING METHOD

(71) Applicants: CHENGDU BOE OPTOELECTRONICS TECHNOLOGY CO., LTD., Sichuan (CN); BOE TECHNOLOGY GROUP CO., LTD., Beijing (CN); Beijing BOE Technology Development Co., Ltd., Beijing (CN)

(72) Inventors: Yuanjie Xu, Beijing (CN); Taofeng Xie, Beijing (CN); Meng Li, Beijing (CN)

(73) Assignees: CHENGDU BOE OPTOELECTRONICS TECHNOLOGY CO., LTD., Sichuan (CN); BOE TECHNOLOGY GROUP CO., LTD., Beijing (CN); Beijing BOE Technology Development Co., Ltd., Beijing (CN)

(21) Appl. No.: 18/996,085

(22) PCT Filed: Sep. 28, 2023
(86) PCT No.: PCT/CN2023/122527

§ 371 Date: Jan. 17, 2025

(30) Foreign Application Priority Data
Nov. 29, 2022 (CN) 202211513331.6
Jul. 21, 2023 (CN) 202310908488.7

(51) Int. Cl. G09G 3/3241

(52) U.S. Cl. CPC G09G 3/3241; G09G 2300/043; G09G 2300/0819; G09G 2300/0842; G09G 2310/08

(57) ABSTRACT

A pixel circuit, a display substrate, a display device and a display driving method are provided. The pixel circuit includes a driving circuit, a data-writing circuit, a data-writing control circuit and a light-emitting element; the data-writing circuit controls the connection or disconnection between the data line and the first end of the driving circuit under the control of a control signal; the data-writing control circuit is configured to control the control signal to control whether the data-writing circuit writes the data voltage to the first end of the driving circuit under the control of the control signal. The present disclosure can realize the display of images at different refresh frequencies in different display areas.

### CROSS-REFERENCE TO RELATED APPLICATION

The present application claims a priority to the Chinese patent application No. 202211513331.6 filed on Nov. 29, 2022 and a priority to the Chinese patent application No. 202310908488.7 filed in China on Jul. 21, 2023, a disclosure of which is incorporated herein by reference in its entirety.

### TECHNICAL FIELD

The present disclosure relates to the field of display technology, and in particular to a pixel circuit, a display substrate, a display device, and a display driving method.

### BACKGROUND

With the development of display technology, the functions of display devices are becoming more and more abundant. Existing display devices can usually support different refresh frequencies. For example, LTPS (Low Temperature Poly-Silicon) display panels usually support the switching of different refresh frequencies such as 60 Hz/90 Hz/120 Hz/144 Hz to adapt to different display requirements. On the basis of LTPS display devices, LTP O (Low Temperature Polycrystalline Oxide) display devices can further support lower refresh frequencies such as 1 to 30 Hz. Since high refresh frequencies consume more power, lower refresh frequencies can be selected while meeting the use requirements. In specific scenarios, there are higher requirements for refresh frequencies. For example, in scenarios such as QR code display and split-screen display, different areas can be controlled to display images at different refresh frequencies.

### SUMMARY

In one aspect, an embodiment of the present disclosure provides a pixel circuit, the pixel circuit including a driving circuit, a data-writing circuit, a data-writing control circuit and a light-emitting element;

The driving circuit is configured to drive the light-emitting element to emit light;

The data-writing circuit is coupled to the control end, the data line and the first end of the driving circuit, and is configured to control the connection or disconnection between the data line and the first end of the driving circuit under the control of the control signal provided by the control end;

The data-writing control circuit is coupled to the control end and is configured to control the control signal to control whether the data-writing circuit writes the data voltage provided by the data line into the first end of the driving circuit under the control of the control signal.

Optionally, the data-writing control circuit is further coupled to the data line and the scanning end, and is configured to control the control signal according to the scanning signal provided by the scanning end under the control of the data voltage provided by the data line.

Optionally, the data-writing control circuit is further coupled to the first voltage end, and is configured to control the connection or disconnection between the scanning terminal and the first voltage end under the control of the data voltage;

The scanning end is coupled to the control end.

Optionally, the data-writing control circuit is further coupled to the first node, and is configured to control the connection or disconnection between the scanning end and the first node under the control of the data voltage, and control the control signal according to the potential of the first node.

Optionally, the data write control circuit is further coupled to the control voltage end, and is configured to control the connection or disconnection between the scanning terminal and the control end under the control of the data voltage, and to control the connection or disconnection between the scanning terminal and the control voltage end under the control of the data voltage.

Optionally, the data-writing control circuit is further coupled to the control node and the scanning end, and is configured to control the connection or disconnection between the control end and the scanning end under the control of the potential of the control node.

Optionally, the pixel circuit described in at least one embodiment of the present disclosure further includes a compensation control circuit;

The compensation control circuit is coupled to the control end, the control end of the driving circuit and the second end of the driving circuit, and is configured to control the connection or disconnection between the control end of the driving circuit and the second end of the driving circuit under the control of the control signal provided by the control end.

Optionally, the data-writing control circuit includes a first transistor;

A gate of the first transistor is coupled to the data line, a first electrode of the first transistor is coupled to the first voltage end, and a second electrode of the first transistor is coupled to the scanning end.

Optionally, the data-writing control circuit includes a first transistor and a first capacitor;

The gate of the first transistor is coupled to the data line, the first electrode of the first transistor is coupled to the scanning end, and the second electrode of the first transistor is coupled to the first node;

A first end of the first capacitor is coupled to the first node, and a second end of the first capacitor is coupled to the control end.

Optionally, the data-writing control circuit includes a first transistor and a second transistor;

The gate of the first transistor is coupled to the data line, the first electrode of the first transistor is coupled to the scanning end, and the second electrode of the first transistor is coupled to the control end;

A gate of the second transistor is coupled to the data line, a first electrode of the second transistor is coupled to the control voltage end, and a second electrode of the second transistor is coupled to the control end.

Optionally, the first transistor is a P-type transistor, and the second transistor is an N-type transistor; or,

The first transistor is an N-type transistor, and the second transistor is a P-type transistor.

Optionally, the control voltage end is a first voltage end or a light-emitting control end.

Optionally, the data-writing control circuit includes a first transistor;

The gate of the first transistor is electrically connected to the control node, the first electrode of the first transistor is electrically connected to the scanning end, and the second electrode of the first transistor is electrically connected to the control end.

Optionally, the pixel circuit described in at least one embodiment of the present disclosure further includes a first light-emitting control circuit, a second light-emitting control circuit, an energy storage circuit and a first initialization circuit;

The first light-emitting control circuit is coupled to the light-emitting control end, the first voltage line and the first end of the driving circuit, and is configured to control the connection or disconnection between the first voltage line and the first end of the driving circuit under the control of the light-emitting control signal provided by the light-emitting control end;

The second light-emitting control circuit is coupled to the light-emitting control end, the second end of the driving circuit and the first electrode of the light-emitting element, and is configured to control the connection or disconnection between the second end of the driving circuit and the first electrode of the light-emitting element under the control of the light-emitting control signal;

The energy storage circuit is coupled to the control end of the driving circuit and is configured to maintain the potential of the control end of the driving circuit;

The first initialization circuit is coupled to the first reset end, the first initialization voltage end and the control end of the driving circuit, and is configured to write the first initialization voltage provided by the first initialization voltage end into the control end of the driving circuit under the control of the first reset signal provided by the first reset end;

The second electrode of the light-emitting element is coupled to the second voltage line;

The driving circuit is configured to generate a driving current for driving the light-emitting element under the control of the potential of the control end.

Optionally, the pixel circuit described in at least one embodiment of the present disclosure further includes a second initialization circuit;

The second initialization circuit is coupled to the second reset end, the second initialization voltage end and the first electrode of the light-emitting element, and is configured to write the second initialization voltage provided by the second initialization voltage end into the first electrode of the light-emitting element under the control of the second reset signal provided by the second reset end.

Optionally, the driving circuit includes a third transistor, the data-writing circuit includes a fourth transistor, the first light-emitting control circuit includes a fifth transistor, the second light-emitting control circuit includes a sixth transistor, the compensation control circuit includes a seventh transistor, the first initialization circuit includes an eighth transistor, and the energy storage circuit includes a storage capacitor;

The gate of the third transistor is coupled to the control end of the driving circuit, the first electrode of the third transistor is coupled to the first end of the driving circuit, and the second electrode of the third transistor is coupled to the second end of the driving circuit;

The gate of the fourth transistor is coupled to the control end, the first electrode of the fourth transistor is coupled to the data line, and the second electrode of the fourth transistor is coupled to the first electrode of the third transistor;

The gate of the fifth transistor is coupled to the light-emitting control end, the first electrode of the fifth transistor is coupled to the first voltage line, and the second electrode of the fifth transistor is coupled to the first electrode of the third transistor;

The gate of the sixth transistor is coupled to the light-emitting control end, the first electrode of the sixth transistor is coupled to the second electrode of the third transistor, and the second electrode of the sixth transistor is coupled to the first electrode of the light-emitting element;

The gate of the seventh transistor is coupled to the control end, the first electrode of the seventh transistor is coupled to the gate of the third transistor, and the second electrode of the seventh transistor is coupled to the second electrode of the third transistor;

The gate of the eighth transistor is coupled to the first reset end, the first electrode of the eighth transistor is coupled to the first initialization voltage end, and the second electrode of the eighth transistor is coupled to the gate of the third transistor;

A first end of the storage capacitor is electrically connected to the gate of the third transistor, and a second end of the storage capacitor is electrically connected to the first voltage line.

Optionally, the second initialization circuit includes a ninth transistor;

The gate of the ninth transistor is coupled to the second reset end, the first electrode of the ninth transistor is coupled to the second initialization voltage end, and the second electrode of the ninth transistor is coupled to the first electrode of the light-emitting element.

In a second aspect, an embodiment of the present disclosure provides a display substrate, including the above-mentioned pixel circuit.

In a third aspect, an embodiment of the present disclosure provides a display device, including the above-mentioned display substrate.

In a fourth aspect, an embodiment of the present disclosure provides a display driving method, which is applied to the above-mentioned display device, where a display area of the display device includes a low refresh rate display area; the low refresh rate display area corresponds to at least one corresponding non-refresh display period; the at least one non-refresh display period is included in the display time; the display driving method includes:

In the low refresh rate display area, during the data-writing phase included in the non-refresh display period, the data-writing control circuit controls the data-writing circuit to stop writing the data voltage into the first end of the driving circuit under the control of the control signal.

Optionally, the display time further includes at least one refresh display period in addition to the at least one non-refresh display period; and the display driving method further includes:

In the data-writing phase included in the refresh display cycle, the data-writing control circuit controls the data-writing circuit to write the data voltage into the first end of the driving circuit under the control of the control signal.

Optionally, the display area of the display device further includes a normal refresh display area; and the display driving method includes:

In the normal refresh display area, during the data-writing phase in each display cycle included in the display time, the data-writing control circuit controls the data-writing circuit to write the data voltage into the first end of the driving circuit under the control of the control signal.

The disclosed embodiment of the present disclosure can realize the data-writing state of the data-writing circuit by setting a data-writing control circuit. When a certain display area is controlled to write data in a normal state, the display area can be kept at a high refresh frequency. When a certain display area is prohibited from writing display data, the display data of the display area remains unchanged during one frame display time or multiple frames of display time, which is equivalent to reducing the refresh frequency of the display area. In this way, the disclosed embodiment of the present disclosure can realize the display of images at different refresh frequencies in different display areas.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a structural diagram of a pixel circuit according to at least one embodiment of the present disclosure;

FIG. 8 is a structural diagram of a pixel circuit according to at least one embodiment of the present disclosure;

FIG. 9 is a structural diagram of a pixel circuit according to at least one embodiment of the present disclosure;

FIG. 10 is a structural diagram of a pixel circuit according to at least one embodiment of the present disclosure;

FIG. 11 is a circuit diagram of a pixel circuit according to at least one embodiment of the present disclosure;

FIG. 12 is a timing diagram of operation of at least one embodiment of the pixel circuit shown in FIG. 11 of the present disclosure;

FIG. 13 is a working timing diagram of at least one embodiment of the pixel circuit shown in FIG. 11 of the present disclosure;

FIG. 14 is a circuit diagram of a pixel circuit according to at least one embodiment of the present disclosure;

FIG. 15A is an operation timing diagram of at least one embodiment of the pixel circuit shown in FIG. 14 of the present disclosure;

FIG. 15B is an operation timing diagram of at least one embodiment of the pixel circuit shown in FIG. 14 of the present disclosure;

FIG. 16 is a circuit diagram of a pixel circuit according to at least one embodiment of the present disclosure;

FIG. 17A is an operation timing diagram of at least one embodiment of the pixel circuit shown in FIG. 16 of the present disclosure;

FIG. 17B is an operation timing diagram of at least one embodiment of the pixel circuit shown in FIG. 16 of the present disclosure;

FIG. 18 is a circuit diagram of a pixel circuit according to at least one embodiment of the present disclosure;

FIG. 19 is a circuit diagram of a pixel circuit according to at least one embodiment of the present disclosure;

FIG. 20A is an operation timing diagram of at least one embodiment of the pixel circuit shown in FIG. 19 of the present disclosure;

FIG. 20B is an operation timing diagram of at least one embodiment of the pixel circuit shown in FIG. 19 of the present disclosure;

FIG. 21A is a waveform diagram of a first case of a data voltage provided by a data line DA;

FIG. 21B is a waveform diagram of a first case of a data voltage provided by the data line DA;

FIG. 21C is a waveform diagram of a first case of a data voltage provided by the data line DA;

FIG. 21D is a waveform diagram of a first case of a data voltage provided by the data line DA;

FIG. 22 is a schematic diagram of a first division of a display area of a display device; and

FIG. 23 is a second schematic diagram of dividing the display area of the display device.

### DETAILED DESCRIPTION

The following will be combined with the drawings in the embodiments of the present disclosure to clearly and completely describe the technical solutions in the embodiments of the present disclosure. Obviously, the described embodiments are only part of the embodiments of the present disclosure, rather than all the embodiments. Based on the embodiments in the present disclosure, all other embodiments obtained by ordinary technicians in this field without making creative work are within the scope of protection of the present disclosure.

Embodiments of the present disclosure provide a pixel circuit, a display substrate including the pixel circuit, a display device including the display substrate, and a display driving method applied to the display device.

In one embodiment, the display substrate includes a substrate and a plurality of sub-pixels arranged on the substrate, the sub-pixels include a light-emitting unit and a pixel circuit driving the light-emitting unit to emit light, and the pixel circuit includes a plurality of transistors.

In the embodiments of the present disclosure, in order to distinguish the two electrodes of the transistor except the control electrode, one of the electrodes is called the first electrode and the other is called the second electrode. When the transistor is a thin film transistor or a field effect transistor, the control electrode of the transistor is further called the gate, the first electrode can be the drain electrode, and the second electrode can be the source electrode; or, the first electrode can be the source electrode, and the second electrode can be the drain electrode.

In one embodiment, the display substrate includes a driving circuit layer, which forms a pixel circuit that drives the light-emitting unit of each sub-pixel. The structure of the pixel circuit can be selected as needed. Each pixel circuit may include multiple transistors and capacitors. The transistors used can be triodes, thin film transistors (TFTs) or field effect transistors or other devices with the same characteristics. In this embodiment, the transistor is only a thin film transistor (TFT) for exemplary description.

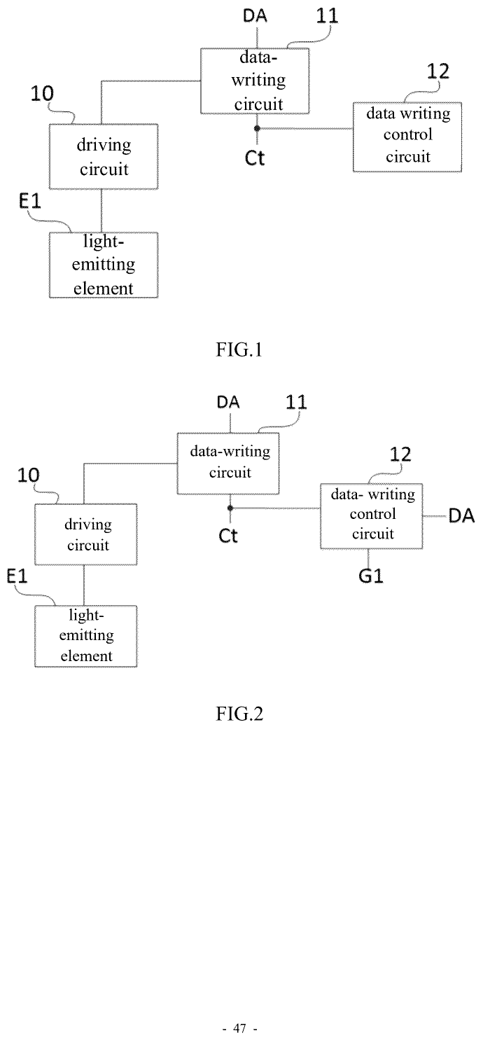

As shown in FIG. 1, the pixel circuit described in the embodiment of the present disclosure includes a driving circuit 10, a data-writing circuit 11, a data-writing control circuit 12, and a light-emitting element E1;

The driving circuit 10 is coupled to the light-emitting element E1 and is configured to drive the light-emitting element E1 to emit light;

The data-writing circuit 11 is coupled to the control end Ct, the data line DA and the first end of the driving circuit 10, and is configured to control the connection or disconnection between the data line DA and the first end of the driving circuit 10 under the control of the control signal provided by the control end Ct;

The data-writing control circuit 12 is coupled to the control end Ct and is configured to control the control signal to control whether the data-writing circuit 11 writes the data voltage Vdata provided by the data line DA into the first end of the driving circuit 10 under the control of the control signal.

The disclosed embodiment can control the data-writing state of the data-writing circuit 11 by setting the data-writing control circuit 12. When a certain display area is controlled to write data in a normal state, the display area can be kept at a high refresh frequency. When a certain display area is prohibited from writing display data, the display data of the display area remains unchanged during one frame display time or multiple frames of display time, which is equivalent to reducing the refresh frequency of the display area. In this way, the disclosed embodiment can display images at different refresh frequencies in different display areas.

In at least one embodiment of the present disclosure, the data write control circuit is further coupled to the data line and the scanning end, and is configured to control the control signal according to the scan signal provided by the scanning end under the control of the data voltage provided by the data line.

In a specific implementation, the data-writing control circuit can also control the control signal provided by the control end according to the scanning signal under the control of the data voltage provided by the data line.

As shown in FIG. 2, based on the embodiment of the pixel circuit shown in FIG. 1, the data write control circuit 12 is further coupled to the data line DA and the scanning terminal G1, and is configured to control the control signal according to the scanning signal provided by the scanning terminal G1 under the control of the data voltage Vdata provided by the data line DA.

In at least one embodiment of the present disclosure, the data-writing control circuit is further coupled to the first voltage end, and is configured to control the connection or disconnection between the scanning terminal and the first voltage end under the control of the data voltage;

The scanning end is coupled to the control end.

In a specific implementation, the data-writing control circuit can control the connection or disconnection between the scanning terminal and the first voltage end under the control of the data voltage, and the scanning terminal is coupled to the control end.

Optionally, the first voltage end may be a high voltage end, but is not limited thereto.

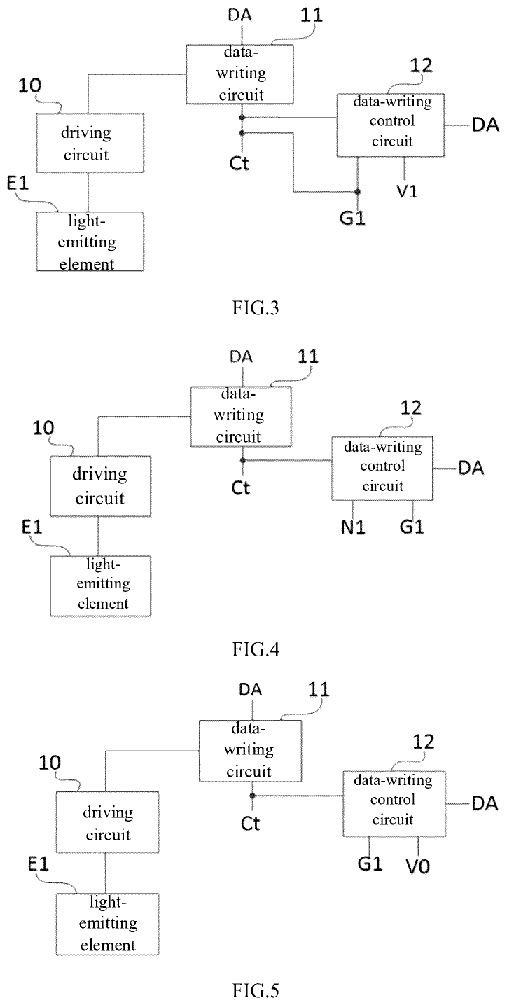

As shown in FIG. 3, based on at least one embodiment of the pixel circuit shown in FIG. 2, the data-writing control circuit 12 is further coupled to the first voltage end V1, and is configured to control the connection or disconnection between the scanning terminal G1 and the first voltage end V1 under the control of the data voltage Vdata;

The scanning terminal G1 is coupled to the control end Ct.

In at least one embodiment of the present disclosure, the data write control circuit is further coupled to the first node, and is configured to control the connection or disconnection between the scanning end and the first node under the control of the data voltage, and control the control signal according to the potential of the first node.

In a specific implementation, the data-writing control circuit can also be coupled to the first node, and under the control of the data voltage, the potential of the first node is controlled according to the scanning signal provided by the scanning end, and the control signal is controlled according to the potential of the first node.

As shown in FIG. 4, based on at least one embodiment of the pixel circuit shown in FIG. 2, the data write control circuit 12 is further coupled to the first node N1, and is configured to control the connection or disconnection between the scanning terminal G1 and the first node N1 under the control of the data voltage Vdata, and control the control signal according to the potential of the first node N1.

In at least one embodiment of the present disclosure, the data write control circuit is further coupled to the control voltage end, and is configured to control the connection or disconnection between the scanning terminal and the control end under the control of the data voltage, and to control the connection or disconnection between the scanning terminal and the control voltage end under the control of the data voltage.

In a specific implementation, the data-writing control circuit may also be coupled to the control voltage end, and under the control of the data voltage, the control signal provided by the control end is controlled according to the scan signal provided by the scanning end or the control voltage provided by the control voltage end.

Optionally, the control voltage end may be a light-emitting control end or a high voltage end, but is not limited thereto.

As shown in FIG. 5, based on at least one embodiment of the pixel circuit shown in FIG. 2, the data write control circuit 12 is further coupled to the control voltage end V0, and is configured to control the connection or disconnection between the scanning terminal G1 and the control end Ct under the control of the data voltage Vdata, and to control the connection or disconnection between the scanning terminal G1 and the control voltage end V0 under the control of the data voltage Vdata.

In at least one embodiment of the present disclosure, the data-writing control circuit is further coupled to the control node and the scanning end, and is configured to control the connection or disconnection between the control end and the scanning end under the control of the potential of the control node.

In a specific implementation, the data-writing control circuit may also be coupled to a control node and a scanning end, and under the control of the potential of the control node, the control signal provided by the control end is controlled according to the scan signal provided by the scanning end.

Optionally, the data-writing control circuit includes a first transistor;

The gate of the first transistor is electrically connected to the control node, the first electrode of the first transistor is electrically connected to the scanning end, and the second electrode of the first transistor is electrically connected to the control end.

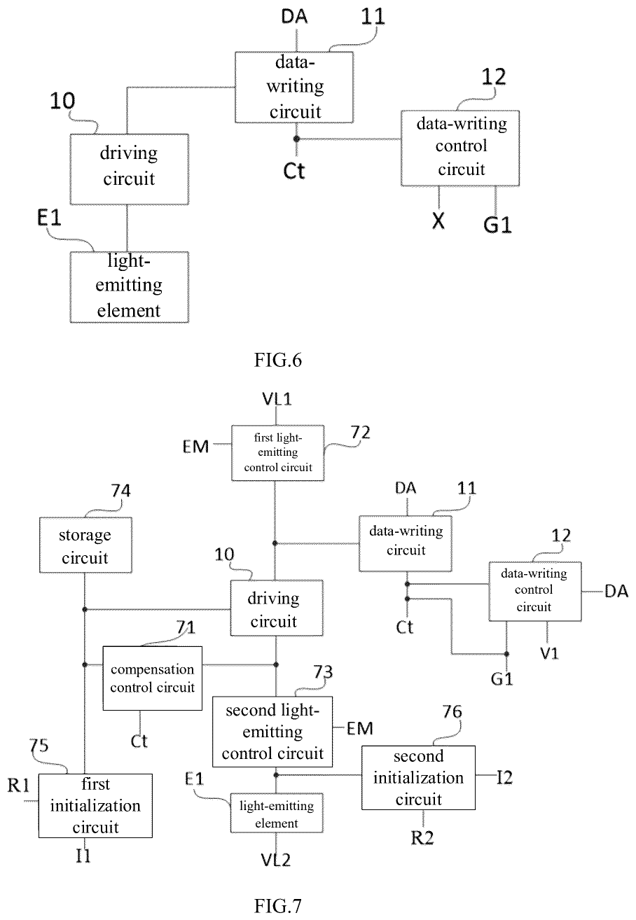

As shown in FIG. 6, based on the embodiment of the pixel circuit shown in FIG. 1, the data write control circuit 12 is further coupled to the control node X and the scanning end G1, and is configured to control the connection or disconnection between the control end Ct and the scanning end G1 under the control of the potential of the control node X.

The pixel circuit described in at least one embodiment of the present disclosure further includes a compensation control circuit;

The compensation control circuit is coupled to the control end, the control end of the driving circuit and the second end of the driving circuit, and is configured to control the connection or disconnection between the control end of the driving circuit and the second end of the driving circuit under the control of the control signal provided by the control end.

In a specific implementation, the pixel circuit described in at least one embodiment of the present disclosure may further include a compensation control circuit, which, under the control of a control signal, controls the connection or disconnection between the control end of the driving circuit and the second end of the driving circuit to perform threshold voltage compensation.

Optionally, the data-writing control circuit includes a first transistor;

A gate of the first transistor is coupled to the data line, a first electrode of the first transistor is coupled to the first voltage end, and a second electrode of the first transistor is coupled to the scanning end.

Optionally, the data-writing control circuit includes a first transistor and a first capacitor;

The gate of the first transistor is coupled to the data line, the first electrode of the first transistor is coupled to the scanning end, and the second electrode of the first transistor is coupled to the first node;

A first end of the first capacitor is coupled to the first node, and a second end of the first capacitor is coupled to the control end.

Optionally, the data-writing control circuit includes a first transistor and a second transistor;

The gate of the first transistor is coupled to the data line, the first electrode of the first transistor is coupled to the scanning end, and the second electrode of the first transistor is coupled to the control end;

A gate of the second transistor is coupled to the data line, a first electrode of the second transistor is coupled to the control voltage end, and a second electrode of the second transistor is coupled to the control end.

In at least one embodiment of the present disclosure, the first transistor is a P-type transistor, and the second transistor is an N-type transistor; or,

The first transistor is an N-type transistor, and the second transistor is a P-type transistor.

Optionally, the control voltage end is a first voltage end or a light-emitting control end.

The pixel circuit described in at least one embodiment of the present disclosure further includes a first light-emitting control circuit, a second light-emitting control circuit, an energy storage circuit and a first initialization circuit;

The first light-emitting control circuit is coupled to the light-emitting control end, the first voltage line and the first end of the driving circuit, and is configured to control the connection or disconnection between the first voltage line and the first end of the driving circuit under the control of the light-emitting control signal provided by the light-emitting control end;

The second light-emitting control circuit is coupled to the light-emitting control end, the second end of the driving circuit and the first electrode of the light-emitting element, and is configured to control the connection or disconnection between the second end of the driving circuit and the first electrode of the light-emitting element under the control of the light-emitting control signal;

The energy storage circuit is coupled to the control end of the driving circuit and is configured to maintain the potential of the control end of the driving circuit;

The first initialization circuit is coupled to the first reset end, the first initialization voltage end and the control end of the driving circuit, and is configured to write the first initialization voltage provided by the first initialization voltage end into the control end of the driving circuit under the control of the first reset signal provided by the first reset end;

The second electrode of the light-emitting element is coupled to the second voltage line;

The driving circuit is configured to generate a driving current for driving the light-emitting element under the control of the potential of the control end.

In a specific implementation, the pixel circuit may further include a first light-emitting control circuit, a second light-emitting control circuit, an energy storage circuit and a first initialization circuit; the first light-emitting control circuit controls the on-off connection between the first voltage line and the first end of the driving circuit under the control of the light-emitting control signal, the second light-emitting control circuit controls the on-off connection between the second end of the driving circuit and the first electrode of the light-emitting element under the control of the light-emitting control signal, the energy storage circuit maintains the potential of the control end of the driving circuit, the first initialization circuit initializes the potential of the control end of the driving circuit under the control of the first reset signal, and the driving circuit drives the light-emitting element to emit light under the control of the potential of its control end.

Optionally, the first voltage line may be a high voltage line, and the second voltage line may be a low voltage line, but is not limited thereto.

The pixel circuit described in at least one embodiment of the present disclosure further includes a second initialization circuit;

The second initialization circuit is coupled to the second reset end, the second initialization voltage end and the first electrode of the light-emitting element, and is configured to write the second initialization voltage provided by the second initialization voltage end into the first electrode of the light-emitting element under the control of the second reset signal provided by the second reset end.

In a specific implementation, the pixel circuit described in at least one embodiment of the present disclosure may further include a second initialization circuit, and the second initialization circuit initializes the potential of the first electrode of the light-emitting element under the control of a second reset signal.

Optionally, the first initialization voltage end and the second initialization voltage end may be the same voltage end, or the first initialization voltage end and the second initialization voltage end may be different voltage ends.

As shown in FIG. 7, based on at least one embodiment of the pixel circuit shown in FIG. 3, the pixel circuit described in at least one embodiment of the present disclosure further includes a compensation control circuit 71, a first light-emitting control circuit 72, a second light-emitting control circuit 73, a storage circuit 74, a first initialization circuit 75, and a second initialization circuit 76;

The compensation control circuit 71 is coupled to the control end Ct, the control end of the driving circuit 10 and the second end of the driving circuit 10, and is configured to control the connection or disconnection between the control end of the driving circuit 10 and the second end of the driving circuit 10 under the control of the control signal provided by the control end Ct;

The first light-emitting control circuit 72 is coupled to the light-emitting control end EM, the first voltage line VL1 and the first end of the driving circuit 10, and is configured to control the connection or disconnection between the first voltage line VL1 and the first end of the driving circuit 10 under the control of the light-emitting control signal provided by the light-emitting control end EM;

The second light-emitting control circuit 73 is coupled to the light-emitting control end EM, the second end of the driving circuit 10 and the first electrode of the light-emitting element E1, and is configured to control the connection or disconnection between the second end of the driving circuit 10 and the first electrode of the light-emitting element E1 under the control of the light-emitting control signal;

The energy storage circuit 74 is coupled to the control end of the driving circuit 10 and is configured to maintain the potential of the control end of the driving circuit 10;

The first initialization circuit 75 is coupled to the first reset end R1, the first initialization voltage end I1 and the control end of the driving circuit 10, and is configured to write the first initialization voltage provided by the first initialization voltage end I1 into the control end of the driving circuit 10 under the control of the first reset signal provided by the first reset end R1;

The second electrode of the light-emitting element E1 is coupled to the second voltage line VL2;

The driving circuit 10 is configured to generate a driving current for driving the light-emitting element E1 under the control of the potential of its control end;

The second initialization circuit 76 is coupled to the second reset end R2, the second initialization voltage end I2 and the first electrode of the light-emitting element E1, and is configured to write the second initialization voltage provided by the second initialization voltage end I3 into the first electrode of the light-emitting element E1 under the control of the second reset signal provided by the second reset end R2.

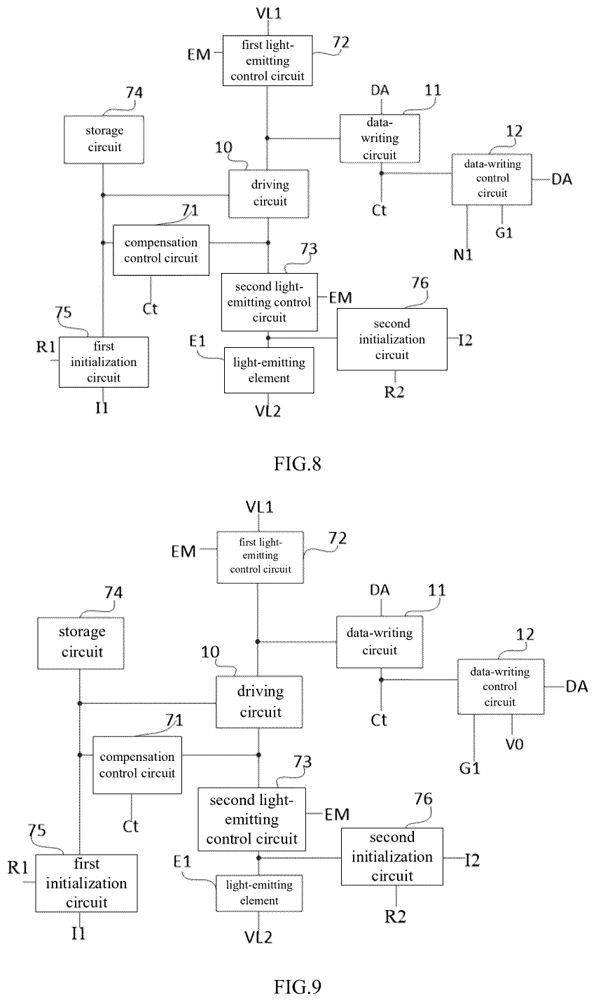

As shown in FIG. 8, based on at least one embodiment of the pixel circuit shown in FIG. 4, the pixel circuit described in at least one embodiment of the present disclosure further includes a compensation control circuit 71, a first light-emitting control circuit 72, a second light-emitting control circuit 73, a storage circuit 74, a first initialization circuit 75, and a second initialization circuit 76;

The compensation control circuit 71 is coupled to the control end Ct, the control end of the driving circuit 10 and the second end of the driving circuit 10, and is configured to control the connection or disconnection between the control end of the driving circuit 10 and the second end of the driving circuit 10 under the control of the control signal provided by the control end Ct;

The first light-emitting control circuit 72 is coupled to the light-emitting control end EM, the first voltage line VL1 and the first end of the driving circuit 10, and is configured to control the connection or disconnection between the first voltage line VL1 and the first end of the driving circuit 10 under the control of the light-emitting control signal provided by the light-emitting control end EM;

The second light-emitting control circuit 73 is coupled to the light-emitting control end EM, the second end of the driving circuit 10 and the first electrode of the light-emitting element E1, and is configured to control the connection or disconnection between the second end of the driving circuit 10 and the first electrode of the light-emitting element E1 under the control of the light-emitting control signal;

The energy storage circuit 74 is coupled to the control end of the driving circuit 10 and is configured to maintain the potential of the control end of the driving circuit 10;

The first initialization circuit 75 is coupled to the first reset end R1, the first initialization voltage end I1 and the control end of the driving circuit 10, and is configured to write the first initialization voltage provided by the first initialization voltage end I1 into the control end of the driving circuit 10 under the control of the first reset signal provided by the first reset end R1;

The second electrode of the light-emitting element E1 is coupled to the second voltage line VL2;

The driving circuit 10 is configured to generate a driving current for driving the light-emitting element E1 under the control of the potential of its control end;

The second initialization circuit 76 is coupled to the second reset end R2, the second initialization voltage end I2 and the first electrode of the light-emitting element E1, and is configured to write the second initialization voltage provided by the second initialization voltage end I3 into the first electrode of the light-emitting element E1 under the control of the second reset signal provided by the second reset end R2.

As shown in FIG. 9, based on at least one embodiment of the pixel circuit shown in FIG. 5, the pixel circuit described in at least one embodiment of the present disclosure further includes a compensation control circuit 71, a first light-emitting control circuit 72, a second light-emitting control circuit 73, a storage circuit 74, a first initialization circuit 75, and a second initialization circuit 76;

The compensation control circuit 71 is coupled to the control end Ct, the control end of the driving circuit 10 and the second end of the driving circuit 10, and is configured to control the connection or disconnection between the control end of the driving circuit 10 and the second end of the driving circuit 10 under the control of the control signal provided by the control end Ct;

The first light-emitting control circuit 72 is coupled to the light-emitting control end EM, the first voltage line VL1 and the first end of the driving circuit 10, and is configured to control the connection or disconnection between the first voltage line VL1 and the first end of the driving circuit 10 under the control of the light-emitting control signal provided by the light-emitting control end EM;

The second light-emitting control circuit 73 is coupled to the light-emitting control end EM, the second end of the driving circuit 10 and the first electrode of the light-emitting element E1, and is configured to control the connection or disconnection between the second end of the driving circuit 10 and the first electrode of the light-emitting element E1 under the control of the light-emitting control signal;

The energy storage circuit 74 is coupled to the control end of the driving circuit 10 and is configured to maintain the potential of the control end of the driving circuit 10;

The first initialization circuit 75 is coupled to the first reset end R1, the first initialization voltage end I1 and the control end of the driving circuit 10, and is configured to write the first initialization voltage provided by the first initialization voltage end I1 into the control end of the driving circuit 10 under the control of the first reset signal provided by the first reset end R1;

The second electrode of the light-emitting element E1 is coupled to the second voltage line VL2;

The driving circuit 10 is configured to generate a driving current for driving the light-emitting element E1 under the control of the potential of its control end;

The second initialization circuit 76 is coupled to the second reset end R2, the second initialization voltage end I2 and the first electrode of the light-emitting element E1, and is configured to write the second initialization voltage provided by the second initialization voltage end I3 into the first electrode of the light-emitting element E1 under the control of the second reset signal provided by the second reset end R2.

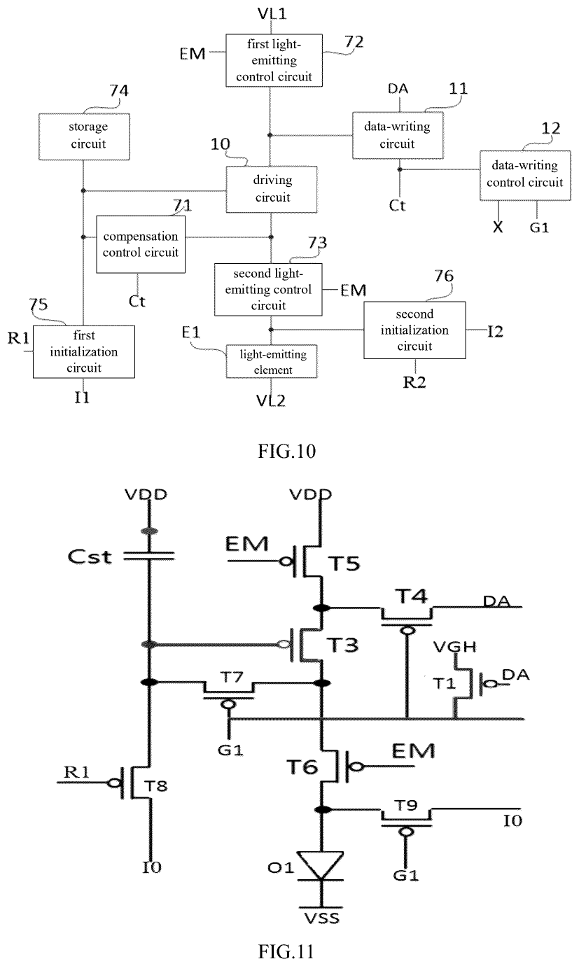

As shown in FIG. 10, based on at least one embodiment of the pixel circuit shown in FIG. 6, the pixel circuit described in at least one embodiment of the present disclosure further includes a compensation control circuit 71, a first light-emitting control circuit 72, a second light-emitting control circuit 73, a storage circuit 74, a first initialization circuit 75, and a second initialization circuit 76;

The compensation control circuit 71 is coupled to the control end Ct, the control end of the driving circuit 10 and the second end of the driving circuit 10, and is configured to control the connection or disconnection between the control end of the driving circuit 10 and the second end of the driving circuit 10 under the control of the control signal provided by the control end Ct;

The first light-emitting control circuit 72 is coupled to the light-emitting control end EM, the first voltage line VL1 and the first end of the driving circuit 10, and is configured to control the connection or disconnection between the first voltage line VL1 and the first end of the driving circuit 10 under the control of the light-emitting control signal provided by the light-emitting control end EM;

The second light-emitting control circuit 73 is coupled to the light-emitting control end EM, the second end of the driving circuit 10 and the first electrode of the light-emitting element E1, and is configured to control the connection or disconnection between the second end of the driving circuit 10 and the first electrode of the light-emitting element E1 under the control of the light-emitting control signal;

The energy storage circuit 74 is coupled to the control end of the driving circuit 10 and is configured to maintain the potential of the control end of the driving circuit 10;

The first initialization circuit 75 is coupled to the first reset end R1, the first initialization voltage end I1 and the control end of the driving circuit 10, and is configured to write the first initialization voltage provided by the first initialization voltage end I1 into the control end of the driving circuit 10 under the control of the first reset signal provided by the first reset end R1;

The second electrode of the light-emitting element E1 is coupled to the second voltage line VL2;

The driving circuit 10 is configured to generate a driving current for driving the light-emitting element E1 under the control of the potential of its control end;

The second initialization circuit 76 is coupled to the second reset end R2, the second initialization voltage end I2 and the first electrode of the light-emitting element E1, and is configured to write the second initialization voltage provided by the second initialization voltage end I3 into the first electrode of the light-emitting element E1 under the control of the second reset signal provided by the second reset end R2.

Optionally, the driving circuit includes a third transistor, the data-writing circuit includes a fourth transistor, the first light-emitting control circuit includes a fifth transistor, the second light-emitting control circuit includes a sixth transistor, the compensation control circuit includes a seventh transistor, the first initialization circuit includes an eighth transistor, and the energy storage circuit includes a storage capacitor;

The gate of the third transistor is coupled to the control end of the driving circuit, the first electrode of the third transistor is coupled to the first end of the driving circuit, and the second electrode of the third transistor is coupled to the second end of the driving circuit;

The gate of the fourth transistor is coupled to the control end, the first electrode of the fourth transistor is coupled to the data line, and the second electrode of the fourth transistor is coupled to the first electrode of the third transistor;

The gate of the fifth transistor is coupled to the light-emitting control end, the first electrode of the fifth transistor is coupled to the first voltage line, and the second electrode of the fifth transistor is coupled to the first electrode of the third transistor;

The gate of the sixth transistor is coupled to the light-emitting control end, the first electrode of the sixth transistor is coupled to the second electrode of the third transistor, and the second electrode of the sixth transistor is coupled to the first electrode of the light-emitting element;

The gate of the seventh transistor is coupled to the control end, the first electrode of the seventh transistor is coupled to the gate of the third transistor, and the second electrode of the seventh transistor is coupled to the second electrode of the third transistor;

The gate of the eighth transistor is coupled to the first reset end, the first electrode of the eighth transistor is coupled to the first initialization voltage end, and the second electrode of the eighth transistor is coupled to the gate of the third transistor;

A first end of the storage capacitor is electrically connected to the gate of the third transistor, and a second end of the storage capacitor is electrically connected to the first voltage line.

Optionally, the second initialization circuit includes a ninth transistor;

The gate of the ninth transistor is coupled to the second reset end, the first electrode of the ninth transistor is coupled to the second initialization voltage end, and the second electrode of the ninth transistor is coupled to the first electrode of the light-emitting element.

As shown in FIG. 11, based on at least one embodiment of the pixel circuit shown in FIG. 7, the data-writing control circuit includes a first transistor T1;

The gate of the first transistor T1 is coupled to the data line DA, the source of the first transistor T1 is coupled to the high voltage end VGH, and the drain of the first transistor T1 is coupled to the scanning terminal G1;

The driving circuit includes a third transistor T3, the data-writing circuit includes a fourth transistor T4, the first light-emitting control circuit includes a fifth transistor T5, the second light-emitting control circuit includes a sixth transistor T6, the compensation control circuit includes a seventh transistor T7, the first initialization circuit includes an eighth transistor T8, and the energy storage circuit includes a storage capacitor Cst; the light-emitting element is an organic light-emitting diode O1;

The gate of the fourth transistor T4 is coupled to the scanning terminal G1, the source of the fourth transistor T4 is coupled to the data line DA, and the drain of the fourth transistor T4 is coupled to the source of the third transistor T3;

The gate of the fifth transistor T5 is coupled to the light-emitting control end EM, the source of the fifth transistor T5 is coupled to the high voltage line VDD, and the drain of the fifth transistor T5 is coupled to the source of the third transistor T3;

The gate of the sixth transistor T6 is coupled to the light-emitting control end EM, the source of the sixth transistor T6 is coupled to the drain of the third transistor T3, and the drain of the sixth transistor T6 is coupled to the anode of the organic light-emitting diode O1;

The gate of the seventh transistor T7 is coupled to the scanning terminal G1, the source of the seventh transistor T7 is coupled to the gate of the third transistor T3, and the drain of the seventh transistor T7 is coupled to the drain of the third transistor T3;

The gate of the eighth transistor T8 is coupled to the first reset end R1, the source of the eighth transistor T8 is coupled to the initialization voltage end 10, and the drain of the eighth transistor T8 is coupled to the gate of the third transistor T3;

The second initialization circuit includes a ninth transistor T9;

The gate of the ninth transistor T9 is coupled to the scanning terminal G1, the source of the ninth transistor T9 is coupled to the initialization voltage end I0, and the drain of the ninth transistor T9 is coupled to the anode of the organic light-emitting diode O1;

A first end of the storage capacitor Cst is electrically connected to the gate of the third transistor T3, and a second end of the storage capacitor Cst is electrically connected to the high voltage line VDD;

A cathode of the organic light-emitting diode O1 is electrically connected to a low voltage line VSS.

In at least one embodiment of the pixel circuit shown in FIG. 11, the control end is coupled to the scanning terminal G1, the first initialization voltage end and the second initialization voltage end are both initialization voltage ends I0, the first voltage end is the high voltage end VGH, the first voltage line is the high voltage line VDD, and the second voltage line is the low voltage line VSS.

In at least one embodiment of the pixel circuit shown in FIG. 11, all transistors are P-type transistors, but the present disclosure is not limited thereto.

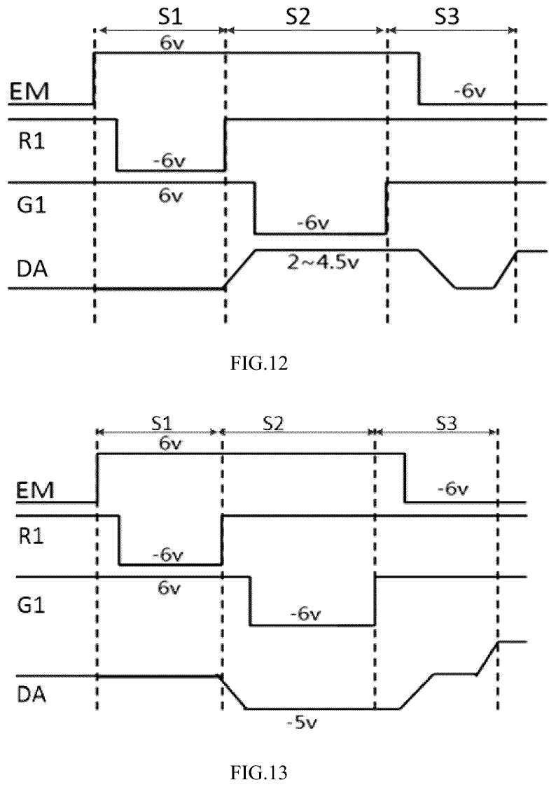

As shown in FIG. 12, when at least one embodiment of the pixel circuit shown in FIG. 11 of the present disclosure is in operation, when display refresh is required, the display cycle includes a reset phase S1, a data-writing phase S2, and a light-emitting phase S3 that are successively arranged;

In the reset phase S1, EM provides a high voltage signal, R1 provides a low voltage signal, G1 provides a high voltage signal, T8 is turned on to write the initialization voltage Vint provided by I0 into the gate of T3, so that T3 can be turned on when the data-writing phase S2 starts; the data voltage Vdata provided by DA is a low voltage, T1 is turned on, G1 is connected to VGH, and T4 and T7 are turned off;

In the data-writing phase S2, EM provides a high voltage signal, R1 provides a high voltage signal, G1 provides a low voltage signal, the voltage value of the data voltage Vdata provided by DA is greater than or equal to 2V and less than or equal to 4.5V, T1 is turned off, T4 and T7 are turned on, the data voltage Vdata provided by DA is written to the source of T3, T7 is turned on to control the connection between the gate of T3 and the drain of T3; T9 is turned on, and the initialization voltage Vint provided by I0 is written to the anode of O1 to control O1 not to emit light and clear the residual charge on the anode of O1;

When S2 is turned on during the data-writing phase, Vdata charges Cst through the turned-on T4, T3, and T7 to change the potential of the gate of T3 until the potential of the gate of T3 becomes Vdata+Vth, and T3 is turned off;

In the light-emitting stage S3, EM provides a low voltage signal, R1 provides a low voltage signal, G1 provides a high voltage signal, Vdata is a low voltage signal, T1 is turned on, G1 is connected to VGH, T5 is turned on, T6 is turned on, and T3 drives O1 to emit light.

As shown in FIG. 13, when at least one embodiment of the pixel circuit shown in FIG. 11 of the present disclosure is in operation, when display refresh is not required, the display cycle includes a reset phase S1, a data-writing phase S2, and a light-emitting phase S3 that are successively arranged;

In the reset phase S1, EM provides a high voltage signal, R1 provides a low voltage signal, G1 provides a high voltage signal, Vdata is a low voltage, and T8 is turned on to write the initialization voltage Vint provided by I0 into the gate of T3;

In the data-writing phase S2, the potential of Vdata is a low voltage, for example, the potential of Vdata may be −5V, T1 is turned on, G1 is connected to VGH, T4 and T7 are turned off, the data voltage is not refreshed, and the potential of the gate of T3 is maintained at the potential of the previous display cycle;

In the light-emitting stage S3, EM provides a low voltage signal, R1 provides a high voltage signal, G1 provides a high voltage signal, the potential of Vdata increases, T5 and T6 are turned on, and T3 drives O1 to emit light.

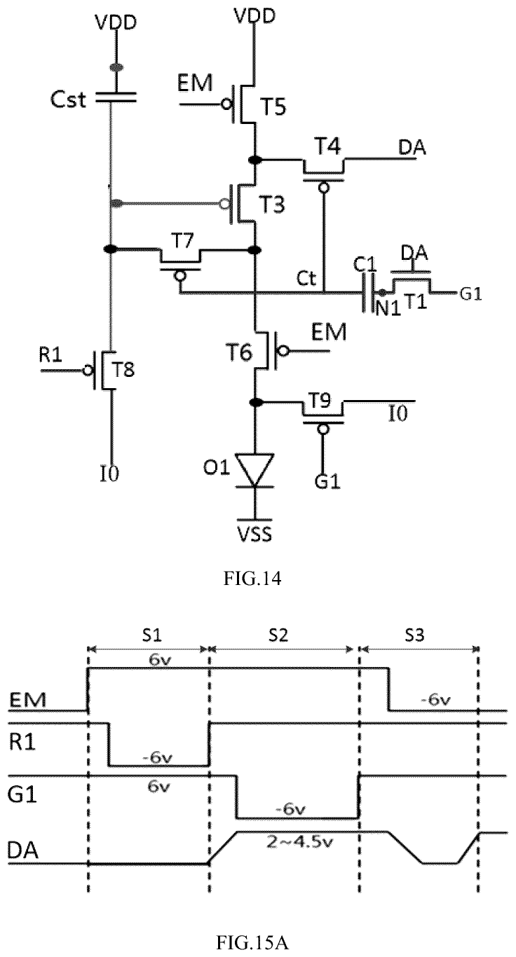

In FIG. 14, based on at least one embodiment of the pixel circuit shown in FIG. 8,

The data-writing control circuit includes a first transistor T1 and a first capacitor C1;

The gate of the first transistor T1 is coupled to the data line DA, the source of the first transistor T1 is coupled to the scanning terminal G1, and the drain of the first transistor T1 is coupled to the first node N1;

A first end of the first capacitor C1 is coupled to the first node N1, and a second end of the first capacitor C1 is coupled to the control end Ct;

The driving circuit includes a third transistor T3, the data-writing circuit includes a fourth transistor T4, the first light-emitting control circuit includes a fifth transistor T5, the second light-emitting control circuit includes a sixth transistor T6, the compensation control circuit includes a seventh transistor T7, the first initialization circuit includes an eighth transistor T8, and the energy storage circuit includes a storage capacitor Cst; the light-emitting element is an organic light-emitting diode O1;

The gate of the fourth transistor T4 is coupled to the control end Ct, the source of the fourth transistor T4 is coupled to the data line DA, and the drain of the fourth transistor T4 is coupled to the source of the third transistor T3;

The gate of the fifth transistor T5 is coupled to the light-emitting control end EM, the source of the fifth transistor T5 is coupled to the high voltage line VDD, and the drain of the fifth transistor T5 is coupled to the source of the third transistor T3;

The gate of the sixth transistor T6 is coupled to the light-emitting control end EM, the source of the sixth transistor T6 is coupled to the drain of the third transistor T3, and the drain of the sixth transistor T6 is coupled to the anode of the organic light-emitting diode O1;

The gate of the seventh transistor T7 is coupled to the control end Ct, the source of the seventh transistor T7 is coupled to the gate of the third transistor T3, and the drain of the seventh transistor T7 is coupled to the drain of the third transistor T3;

The gate of the eighth transistor T8 is coupled to the first reset end R1, the source of the eighth transistor T8 is coupled to the initialization voltage end I0, and the drain of the eighth transistor T8 is coupled to the gate of the third transistor T3;

The second initialization circuit includes a ninth transistor T9;

The gate of the ninth transistor T9 is coupled to the scanning terminal G1, the source of the ninth transistor T9 is coupled to the initialization voltage end I0, and the drain of the ninth transistor T9 is coupled to the anode of the organic light-emitting diode O1;

The first end of the storage capacitor Cst is electrically connected to the gate of T3, and the second end of the storage capacitor Cst is electrically connected to the high voltage line VDD;

A cathode of the organic light-emitting diode O1 is electrically connected to a low voltage line VSS.

In at least one embodiment of the pixel circuit shown in FIG. 14, T1 is an N-type transistor, and the other transistors are P-type transistors, but the present disclosure is not limited thereto.

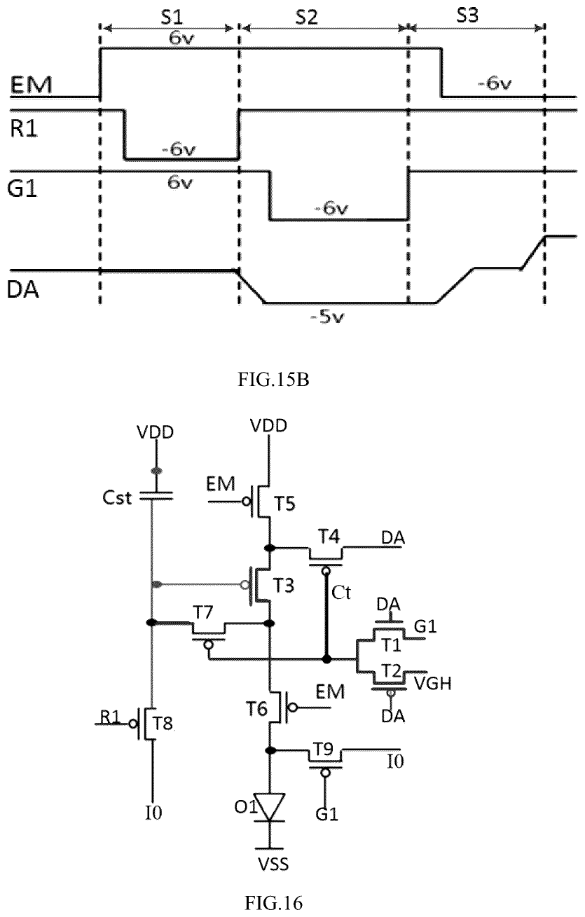

As shown in FIG. 15A, at least one embodiment of the pixel circuit shown in FIG. 14 of the present disclosure is in operation, when a display refresh is required, the display cycle includes a reset phase S1, a data-writing phase S2 and a light-emitting phase S3 which are successively set;

In the reset phase S1, EM provides a high voltage signal, R1 provides a low voltage signal, G1 provides a high voltage signal, the data voltage Vdata provided by DA is a low voltage signal, T8 is turned on to write the initialization voltage Vint provided by I0 into the gate of T3, so that T3 can be turned on when the data-writing phase S2 starts;

In the data-writing phase S2, EM provides a high voltage signal, R1 provides a high voltage signal, G1 provides a low voltage signal, the voltage value of the data voltage Vdata provided by DA is greater than or equal to 2V and less than or equal to 4.5V, T1 is turned on, G1 is connected to the first node N1, T4 and T7 are turned on, the data voltage provided by DA is written to the source of T3, the gate of T3 is connected to the drain of T3, and the data voltage writing and threshold voltage compensation are performed normally;

At the beginning of the data-writing phase S2, T3 is turned on, and Vdata charges Cst through the turned-on T4, T3, and T7 to change the potential of the gate of T3 until the gate potential of T3 becomes Vdata+Vth, where Vth is the threshold voltage of T3;

In the light-emitting stage S3, EM provides a low voltage signal, R1 provides a high voltage signal, G1 provides a high voltage signal, the data voltage Vdata provided by DA is a low voltage signal, T5 and T6 are turned on, and T3 drives O1 to emit light.

As shown in FIG. 15B, at least one embodiment of the pixel circuit shown in FIG. 14 of the present disclosure is in operation, when the display refresh is not required, the display cycle includes a reset phase S1, a data-writing phase S2 and a light-emitting phase S3 which are successively set;

In the reset phase S1, EM provides a high voltage signal, R1 provides a low voltage signal, G1 provides a high voltage signal, the data voltage Vdata provided by DA is a high voltage signal, and T8 is turned on to write the initialization voltage Vint provided by I0 into the gate of T3;

In the data-writing phase S2, EM provides a high voltage signal, R1 provides a high voltage signal, G1 provides a low voltage signal, the voltage value of the data voltage Vdata provided by DA is −5V, T1 is turned off, G1 is disconnected from the first node N1, T4 and T7 are turned off, the data voltage is not refreshed, and the potential of the gate of T3 is maintained at the potential of the previous display cycle;

In the light-emitting stage S3, EM provides a low voltage signal, R1 provides a high voltage signal, G1 provides a high voltage signal, the data voltage Vdata provided by DA is a low voltage signal, T5 and T6 are turned on, and T3 drives O1 to emit light.

As shown in FIG. 16, based on at least one embodiment of the pixel circuit shown in FIG. 9,

The data-writing control circuit includes a first transistor T1 and a second transistor T2;

The gate of the first transistor T1 is coupled to the data line DA, the source of the first transistor T1 is coupled to the scanning terminal G1, and the drain of the first transistor T1 is coupled to the control end Ct;

The gate of the second transistor T2 is coupled to the data line DA, the source of the second transistor T2 is coupled to the high voltage end VGH, and the drain of the second transistor T2 is coupled to the control end Ct;

The driving circuit includes a third transistor T3, the data-writing circuit includes a fourth transistor T4, the first light-emitting control circuit includes a fifth transistor T5, the second light-emitting control circuit includes a sixth transistor T6, the compensation control circuit includes a seventh transistor T7, the first initialization circuit includes an eighth transistor T8, and the energy storage circuit includes a storage capacitor Cst; the light-emitting element is an organic light-emitting diode O1;

The gate of the fourth transistor T4 is coupled to the control end Ct, the source of the fourth transistor T4 is coupled to the data line DA, and the drain of the fourth transistor T4 is coupled to the source of the third transistor T3;

The gate of the fifth transistor T5 is coupled to the light-emitting control end EM, the source of the fifth transistor T5 is coupled to the high voltage line VDD, and the drain of the fifth transistor T5 is coupled to the source of the third transistor T3;

The gate of the sixth transistor T6 is coupled to the light-emitting control end EM, the source of the sixth transistor T6 is coupled to the drain of the third transistor T3, and the drain of the sixth transistor T6 is coupled to the anode of the organic light-emitting diode O1;

The gate of the seventh transistor T7 is coupled to the control end Ct, the source of the seventh transistor T7 is coupled to the gate of the third transistor T3, and the drain of the seventh transistor T7 is coupled to the drain of the third transistor T3;

The gate of the eighth transistor T8 is coupled to the first reset end R1, the source of the eighth transistor T8 is coupled to the initialization voltage end I0, and the drain of the eighth transistor T8 is coupled to the gate of the third transistor T3;

The second initialization circuit includes a ninth transistor T9;

The gate of the ninth transistor T9 is coupled to the scanning terminal G1, the source of the ninth transistor T9 is coupled to the initialization voltage end I0, and the drain of the ninth transistor T9 is coupled to the anode of the organic light-emitting diode O1;

The first end of the storage capacitor Cst is electrically connected to the gate of T3, and the second end of the storage capacitor Cst is electrically connected to the high voltage line VDD;

A cathode of the organic light-emitting diode O1 is electrically connected to a low voltage line VSS.

In at least one embodiment of the pixel circuit shown in FIG. 16, the control voltage end is a high voltage end VGH.

In at least one embodiment of the pixel circuit shown in FIG. 16, T2 is a P-type transistor, and T1 is an N-type transistor.

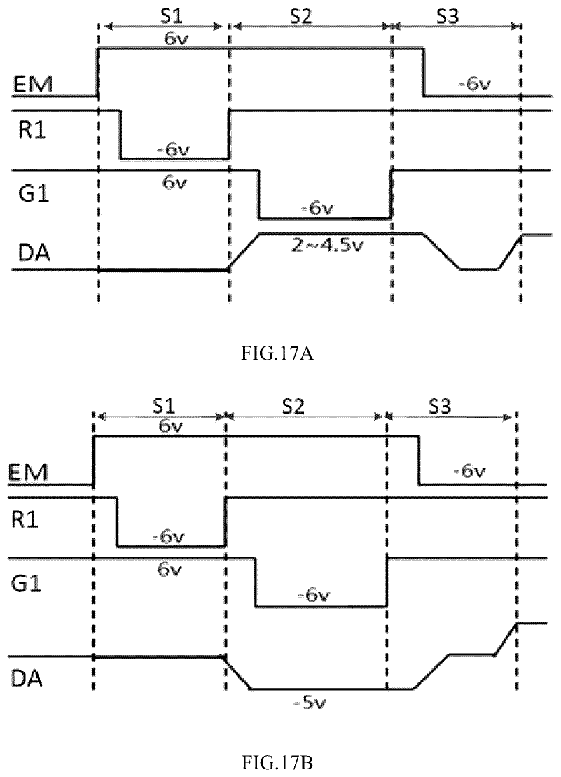

As shown in FIG. 17A, when at least one embodiment of the pixel circuit shown in FIG. 16 of the present disclosure is in operation, when display refresh is required, the display cycle includes a reset phase S1, a data-writing phase S2, and a light-emitting phase S3 that are successively arranged;

In the reset phase S1, EM provides a high voltage signal, R1 provides a low voltage signal, G1 provides a high voltage signal, the potential of the data voltage Vdata provided by DA is a low voltage, T1 is turned off, T2 is turned on, Ct is connected to VGH, T4 and T7 are turned off, T1 is turned on, and the initialization voltage Vint provided by I0 is written into the gate of T3, so that T3 can be turned on when the data-writing phase S2 starts;

In the data-writing phase S2, EM provides a high voltage signal, R1 provides a high voltage signal, G1 provides a low voltage signal, DA provides a data voltage Vdata whose voltage value is greater than or equal to 2V and less than or equal to 4.5V, T1 is turned on, T2 is turned off, Ct is connected to G1, and T4 and T7 are turned on;

At the beginning of the data-writing phase S2, Vdata charges Cst through the turned-on T4, T3 and T7, changing the potential of the gate of T3 until T3 is turned off. At this time, the gate potential of T3 is Vdata+Vth, where Vth is the threshold voltage of T3;

In the light-emitting stage S3, EM provides a low voltage signal, R1 provides a high voltage signal, G1 provides a high voltage signal, the potential of the data voltage Vdata provided by DA is a low voltage, T2 is turned on, Ct is connected to G1, T4 and T7 are turned off, T5 is turned on, and T3 drives O1 to emit light.

As shown in FIG. 17B, when at least one embodiment of the pixel circuit shown in FIG. 16 of the present disclosure is in operation and when display refresh is not required, the display cycle includes a reset phase S1, a data-writing phase S2, and a light-emitting phase S3 that are successively arranged;

In the reset phase S1, EM provides a high voltage signal, R1 provides a low voltage signal, G1 provides a high voltage signal, the voltage value of the data voltage Vdata provided by DA is a high voltage, T1 is turned on, T2 is turned off, Ct is connected to G1, T4 and T7 are turned off, T8 is turned on, and I0 provides an initialization voltage Vint to the gate of T3;

In the data-writing phase S2, EM provides a high voltage signal, R1 provides a high voltage signal, G1 provides a low voltage signal, the potential of the data voltage Vdata provided by DA is −5V, T1 is turned off, T2 is turned on, Ct is connected to VGH, T4 and T7 are turned off, the data voltage is not refreshed, and the potential of the gate of T3 is maintained at the potential of the previous display cycle;

In the light-emitting stage S3, EM provides a low voltage signal, R1 provides a high voltage signal, G1 provides a high voltage signal, the potential of the data voltage Vdata provided by DA increases, T5 is turned on, and T3 drives O1 to emit light.

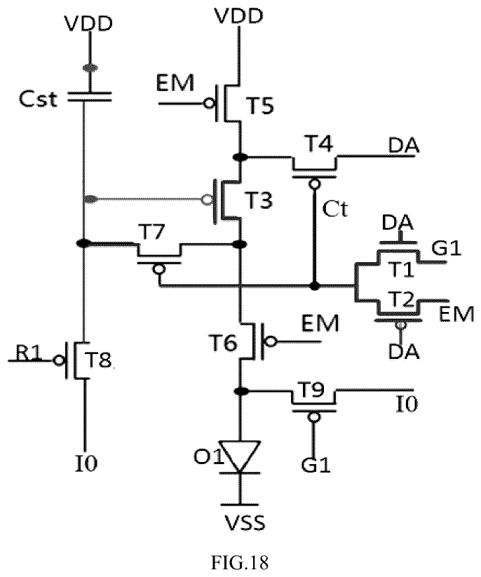

At least one embodiment of the pixel circuit shown in FIG. 18 of the present disclosure is similar to at least one embodiment of the pixel circuit shown in FIG. 16 of the present disclosure in that the source of T2 is electrically connected to the light-emitting control end EM.

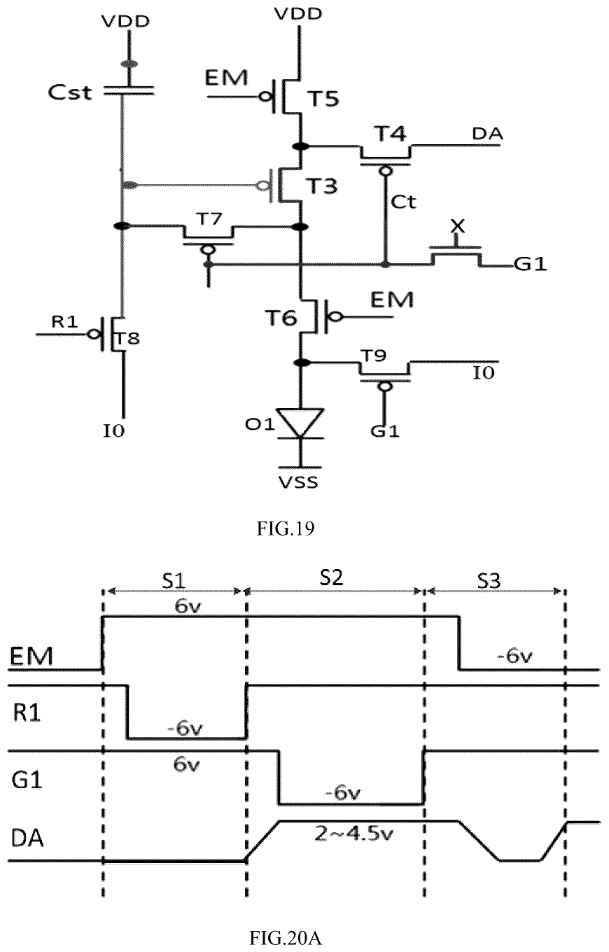

As shown in FIG. 19, based on at least one embodiment of the pixel circuit shown in FIG. 10, the data-writing control circuit includes a first transistor T1;

The gate of the first transistor T1 is electrically connected to the control node X, the source of the first transistor T1 is electrically connected to the scanning terminal G1, and the drain of the first transistor T1 is electrically connected to the control end Ct;

The driving circuit includes a third transistor T3, the data-writing circuit includes a fourth transistor T4, the first light-emitting control circuit includes a fifth transistor T5, the second light-emitting control circuit includes a sixth transistor T6, the compensation control circuit includes a seventh transistor T7, the first initialization circuit includes an eighth transistor T8, and the energy storage circuit includes a storage capacitor Cst; the light-emitting element is an organic light-emitting diode O1;

The gate of the fourth transistor T4 is coupled to the control end Ct, the source of the fourth transistor T4 is coupled to the data line DA, and the drain of the fourth transistor T4 is coupled to the source of the third transistor T3;

The gate of the fifth transistor T5 is coupled to the light-emitting control end EM, the source of the fifth transistor T5 is coupled to the high voltage line VDD, and the drain of the fifth transistor T5 is coupled to the source of the third transistor T3;

The gate of the sixth transistor T6 is coupled to the light-emitting control end EM, the source of the sixth transistor T6 is coupled to the drain of the third transistor T3, and the drain of the sixth transistor T6 is coupled to the anode of the organic light-emitting diode O1;

The gate of the seventh transistor T7 is coupled to the control end Ct, the source of the seventh transistor T7 is coupled to the gate of the third transistor T3, and the drain of the seventh transistor T7 is coupled to the drain of the third transistor T3;

The gate of the eighth transistor T8 is coupled to the first reset end R1, the source of the eighth transistor T8 is coupled to the initialization voltage end I0, and the drain of the eighth transistor T8 is coupled to the gate of the third transistor T3;

The second initialization circuit includes a ninth transistor T9;

The gate of the ninth transistor T9 is coupled to the scanning terminal G1, the source of the ninth transistor T9 is coupled to the initialization voltage end I0, and the drain of the ninth transistor T9 is coupled to the anode of the organic light-emitting diode O1;

The first end of the storage capacitor Cst is electrically connected to the gate of T3, and the second end of the storage capacitor Cst is electrically connected to the high voltage line VDD;

A cathode of the organic light-emitting diode O1 is electrically connected to a low voltage line VSS.

In at least one embodiment of the pixel circuit shown in FIG. 19, all transistors are P-type transistors, but the present disclosure is not limited thereto.

In at least one embodiment of the pixel circuit shown in FIG. 19 of the present disclosure, when display refresh is required, X provides a low voltage signal, Ct and G1 are connected, and the data voltage can be refreshed normally. However, when display refresh is not required, X provides a high voltage signal, Ct and G1 are disconnected, and the new data voltage cannot be written into the third transistor. Here, it is necessary to provide a corresponding voltage signal for the control node X in each pixel circuit according to the divided display area to control whether the pixel circuit performs display refresh.

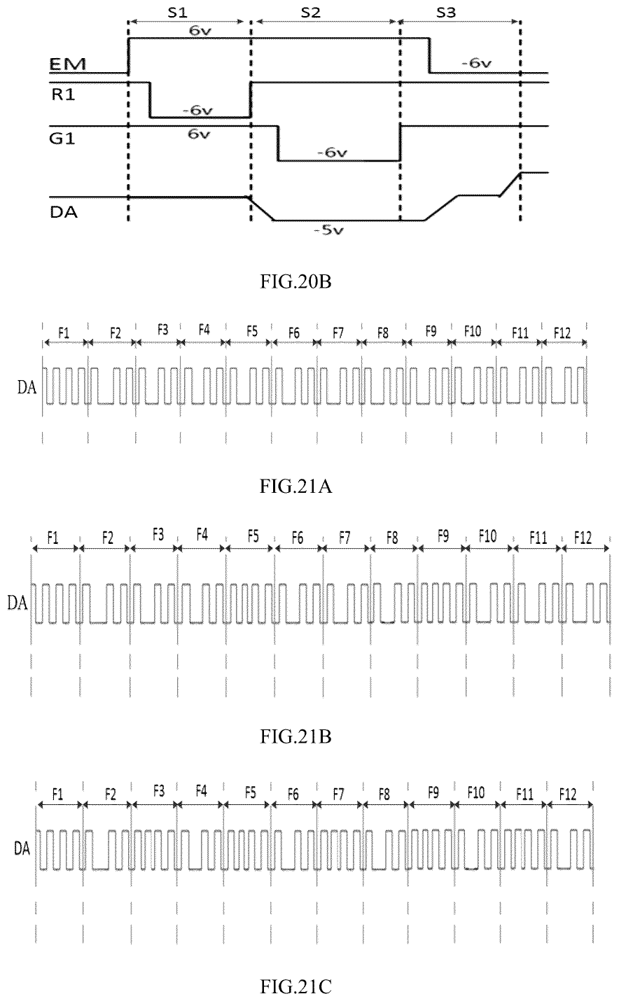

As shown in FIG. 20A, when at least one embodiment of the pixel circuit shown in FIG. 19 of the present disclosure is in operation and needs to refresh the display, X provides a low voltage signal, so that T1 is turned on, and G1 is connected to Ct;

The display cycle includes a reset phase S1, a data-writing phase S2 and a light-emitting phase S3 which are arranged successively;

In the reset phase S1, EM provides a high voltage signal, R1 provides a low voltage signal, G1 provides a high voltage signal, T1 is turned on, and I0 provides an initialization voltage Vint to the gate of T3, so that T3 can be turned on when the data-writing phase S2 begins;

In the data-writing phase S2, EM provides a high voltage signal, R1 provides a high voltage signal, G1 provides a low voltage signal, T4 and T7 are turned on, and the data line DA provides a data voltage Vdata to the source of T3;

At the beginning of the data-writing phase S2, T3 is turned on, and Vdata charges Cst through the turned-on T4, T3, and T7 to change the potential of the gate of T3 until T3 is turned off. At this time, the gate potential of T3 is Vdata+Vth, where Vth is the threshold voltage of T3.

In the light-emitting stage S3, EM provides a low voltage signal, R1 provides a high voltage signal, G1 provides a high voltage signal, T5 is turned on, and T3 drives O1 to emit light.

As shown in FIG. 20B, when at least one embodiment of the pixel circuit shown in FIG. 19 of the present disclosure is in operation and does not need to refresh the display, X provides a high voltage signal, so that T1 is turned off, and Ct is disconnected from G1;

The display cycle includes a reset phase S1, a data-writing phase S2 and a light-emitting phase S3 which are arranged successively;

In the reset phase S1, EM provides a high voltage signal, R1 provides a low voltage signal, G1 provides a high voltage signal, and T8 is turned on to write the initialization voltage Vint provided by I0 into the gate of T3;

In the data-writing phase S2, EM provides a high voltage signal, R1 provides a high voltage signal, G1 provides a low voltage signal, T9 is turned on, and I0 provides an initialization voltage Vint to the anode of O1, so that O1 does not emit light and clears the residual charge on the anode of O1; at this time, T4 and T7 are both turned off, and the data voltage is not refreshed, and the potential of the gate of T3 is maintained at the potential of the previous display cycle;

In the light-emitting stage S3, EM provides a low voltage signal, R1 provides a high voltage signal, G1 provides a high voltage signal, T5 is turned on, and T3 drives O1 to emit light.

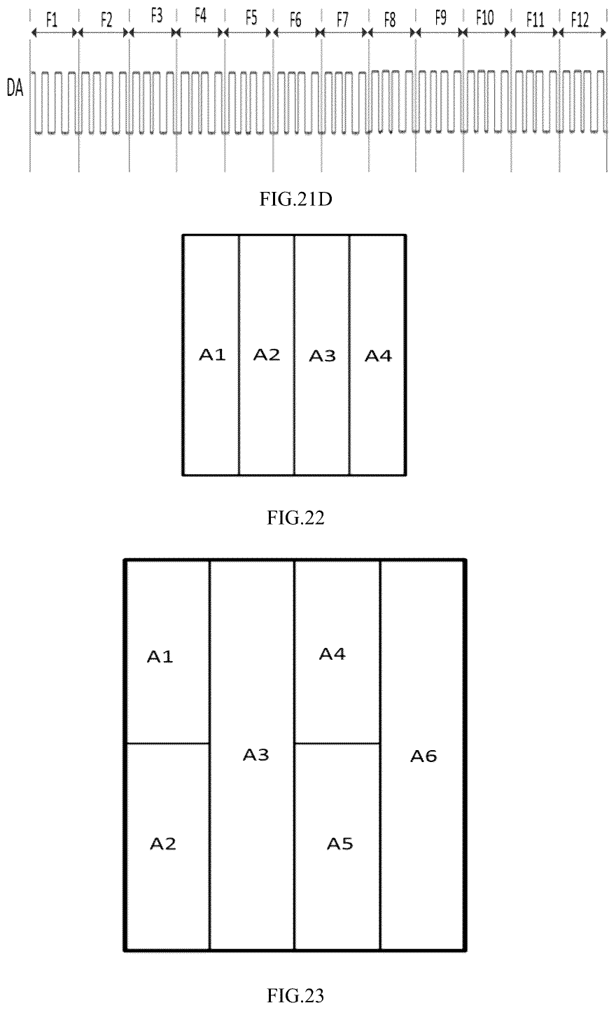

As shown in FIG. 21A, F1 is the first display cycle, F2 is the second display cycle, F3 is the third display cycle, F4 is the fourth display cycle, F5 is the fifth display cycle, F6 is the sixth display cycle, F7 is the seventh display cycle, F8 is the fourth display cycle, F9 is the ninth display cycle, F10 is the tenth display cycle, F11 is the eleventh display cycle, and F12 is the twelfth display cycle;

In the first display cycle F1, the data voltage Vdata provided by DA is the data voltage for controlling display refresh;

In the second display cycle F2, the third display cycle F3, the fourth display cycle F4, the fifth display cycle F5, the sixth display cycle F6, the seventh display cycle F7, the eighth display cycle F8, the ninth display cycle F9, the tenth display cycle F10, the eleventh display cycle F11 and the twelfth display cycle F12, the voltage provided by DA is the data voltage for controlling not to refresh the display;

As shown in FIG. 21A, the display refresh frequency may be 10 Hz.

As shown in FIG. 21B, F1 is the first display cycle, F2 is the second display cycle, F3 is the third display cycle, F4 is the fourth display cycle, F5 is the fifth display cycle, F6 is the sixth display cycle, F7 is the seventh display cycle, F8 is the fourth display cycle, F9 is the ninth display cycle, F10 is the tenth display cycle, F11 is the eleventh display cycle, and F12 is the twelfth display cycle;

In the first display cycle F1, the fifth display cycle F5 and the ninth display cycle F9, the data voltage Vdata provided by DA is the data voltage for controlling display refresh;

In the second display cycle F2, the third display cycle F3, the fourth display cycle F4, the sixth display cycle F6, the seventh display cycle F7, the eighth display cycle F8, the tenth display cycle F10, the eleventh display cycle F11 and the twelfth display cycle F12, the voltage provided by DA is the data voltage for controlling not to refresh the display;

As shown in FIG. 21B, the display refresh frequency may be 30 Hz.

As shown in FIG. 21C, F1 is the first display cycle, F2 is the second display cycle, F3 is the third display cycle, F4 is the fourth display cycle, F5 is the fifth display cycle, F6 is the sixth display cycle, F7 is the seventh display cycle, F8 is the fourth display cycle, F9 is the ninth display cycle, F10 is the tenth display cycle, F11 is the eleventh display cycle, and F12 is the twelfth display cycle;

In the first display cycle F1, the third display cycle F3, the fifth display cycle F5, the seventh display cycle F7, the ninth display cycle F9 and the eleventh display cycle F11, the data voltage Vdata provided by DA is the data voltage for controlling display refresh;

In the second display cycle F2, the fourth display cycle F4, the sixth display cycle F6, the eighth display cycle F8, the tenth display cycle F10 and the twelfth display cycle F12, the voltage provided by DA is a data voltage for controlling not to refresh the display;

As shown in FIG. 21C, the display refresh frequency may be 60 Hz.

As shown in FIG. 21D, F1 is the first display cycle, F2 is the second display cycle, F3 is the third display cycle, F4 is the fourth display cycle, F5 is the fifth display cycle, F6 is the sixth display cycle, F7 is the seventh display cycle, F8 is the fourth display cycle, F9 is the ninth display cycle, F10 is the tenth display cycle, F11 is the eleventh display cycle, and F12 is the twelfth display cycle;

In the first display cycle F1, the second display cycle F2, the third display cycle F3, the fourth display cycle F4, the fifth display cycle F5, the sixth display cycle F6, the seventh display cycle F7, the eighth display cycle F8, the ninth display cycle F9, the tenth display cycle F10, the eleventh display cycle F11 and the twelfth display cycle F12, the data voltage Vdata provided by DA is the data voltage for controlling display refresh;

As shown in FIG. 21D, the display refresh rate may be 120 Hz.

The display substrate described in the embodiment of the present disclosure includes the above-mentioned pixel circuit.

The display device described in the embodiment of the present disclosure includes the above-mentioned display substrate.

In one embodiment, the display area of the display device may include multiple display areas, as shown in FIG. 22, where each display area may be arranged along a first direction of the display substrate, where the first direction refers to the extension direction of the scan line of the display substrate, and in other embodiments, each display area may also be arranged along a second direction of the display substrate, where the second direction is a direction intersecting the first direction. As shown in FIG. 23, in other embodiments, each display area may also be arranged in a combination of horizontal and vertical directions, and different display areas have different refresh frequencies.

In FIG. 22, the area labeled A1 is the first display area, the area labeled A2 is the second display area, the area labeled A3 is the third display area, and the area labeled A4 is the fourth display area;

The first display area A1, the second display area A2, the third display area A3 and the fourth display area A4 are arranged along the horizontal direction;

The display refresh frequency corresponding to A1 may be 60 Hz, the display refresh frequency corresponding to A2 may be 30 Hz, the display refresh frequency corresponding to A3 may be 120 Hz, and the display refresh frequency corresponding to A4 may be 10 Hz.

In FIG. 23, A1 is the first display area, A2 is the second display area, A3 is the third display area, A4 is the fourth display area, A5 is the fifth display area, and A6 is the sixth display area;

The display refresh frequency corresponding to A1 may be 60 Hz, the display refresh frequency corresponding to A2 may be 30 Hz, the display refresh frequency corresponding to A3 may be 30 Hz, the display refresh frequency corresponding to A4 may be 120 Hz, the display refresh frequency corresponding to A3 may be 60 Hz, and the display refresh frequency corresponding to A4 may be 10 Hz.

The display driving method described in the embodiment of the present disclosure is applied to the above-mentioned display device, where the display area of the display device includes a low refresh rate display area; the low refresh rate display area corresponds to at least one corresponding non-refresh display period; the at least one non-refresh display period is included in the display time; the display driving method includes:

In the low refresh rate display area, during the data-writing phase included in the non-refresh display period, the data-writing control circuit controls the data-writing circuit to stop writing the data voltage into the first end of the driving circuit under the control of the control signal.

In at least one embodiment of the present disclosure, the display time further includes at least one refresh display period in addition to the at least one non-refresh display period; and the display driving method further includes:

In the data-writing phase included in the refresh display cycle, the data-writing control circuit controls the data-writing circuit to write the data voltage into the first end of the driving circuit under the control of the control signal.

In at least one embodiment of the present disclosure, the display area of the display device further includes a normal refresh display area; and the display driving method includes:

In the normal refresh display area, during the data-writing phase in each display cycle included in the display time, the data-writing control circuit controls the data-writing circuit to write the data voltage into the first end of the driving circuit under the control of the control signal.

Exemplarily, if the refresh rate of the display device is 120 Hz, at the 2a-1 frame display time, the first target display area and the second target display area both write display data with reference to the normal display mode. a is a positive integer.

During the 2a frame display time, the first display area still writes display data normally, and the second display area is prohibited from writing display data. In this way, the refresh frequency of the first display area is 120 Hz; in the second display area, under the control of the data write control circuit, if only one frame of display time out of every two frames of display time writes display data, and the other frame is prohibited from writing data, then the refresh frequency of the second display area can be understood as becoming 60 Hz, thereby making the refresh frequency of the second target display area less than the refresh frequency of the first target display area.

With reference to the above control process, by adjusting the ratio between the number of image frames normally written with display data and the number of target frames, it is possible to adjust the refresh frequency of the second target display area.

The above is a preferred embodiment of the present disclosure. It should be pointed out that for ordinary technicians in this technical field, several improvements and modifications can be made without departing from the principles described in the present disclosure. These improvements and modifications should also be regarded as the scope of protection of the present disclosure.

1. A pixel circuit, comprising a driving circuit, a data-writing circuit, a data-writing control circuit and a light-emitting element; wherein
the driving circuit is configured to drive the light-emitting element to emit light;
the data-writing circuit is coupled to a control end, a data line and a first end of the driving circuit, and is configured to control a connection or disconnection between the data line and the first end of the driving circuit under a control of a control signal provided by the control end;
the data-writing control circuit is coupled to the control end and is configured to control the control signal to control whether the data-writing circuit writes a data voltage provided by the data line into the first end of the driving circuit under the control of the control signal.

2. The pixel circuit according to claim 1, wherein the data-writing control circuit is further coupled to the data line and a scanning end, and is configured to control the control signal according to a scanning signal provided by the scanning end under a control of the data voltage provided by the data line.

3. The pixel circuit according to claim 2, wherein the data-writing control circuit is further coupled to the first voltage end, and is configured to control a connection or disconnection between the scanning terminal and the first voltage end under the control of the data voltage;
the scanning end is coupled to the control end.

4. The pixel circuit according to claim 2, wherein the data-writing control circuit is further coupled to a first node, and is configured to control a connection or disconnection between the scanning end and the first node under the control of the data voltage, and control the control signal according to a potential of the first node.

5. The pixel circuit according to claim 2, wherein the data-writing control circuit is further coupled to the control voltage end, and is configured to control a connection or disconnection between the scanning terminal and the control end under the control of the data voltage, and to control a connection or disconnection between the scanning terminal and the control voltage end under the control of the data voltage.

6. The pixel circuit according to claim 1, wherein the data-writing control circuit is further coupled to a control node and a scanning end, and is configured to control a connection or disconnection between the control end and the scanning end under the control of a potential of the control node.

7. The pixel circuit according to claim 1, further comprising a compensation control circuit; wherein
the compensation control circuit is coupled to the control end, a control end of the driving circuit and a second end of the driving circuit, and is configured to control a connection or disconnection between the control end of the driving circuit and the second end of the driving circuit under a control of a control signal provided by the control end.

8. The pixel circuit according to claim 3, wherein the data-writing control circuit comprises a first transistor;
a gate of the first transistor is coupled to the data line, a first electrode of the first transistor is coupled to the first voltage end, and a second electrode of the first transistor is coupled to the scanning end.

9. The pixel circuit according to claim 4, wherein the data-writing control circuit comprises a first transistor and a first capacitor;
a gate of the first transistor is coupled to the data line, a first electrode of the first transistor is coupled to the scanning end, and a second electrode of the first transistor is coupled to the first node;
a first end of the first capacitor is coupled to the first node, and a second end of the first capacitor is coupled to the control end.

10. The pixel circuit according to claim 5, wherein the data-writing control circuit comprises a first transistor and a second transistor;
a gate of the first transistor is coupled to the data line, a first electrode of the first transistor is coupled to the scanning end, and a second electrode of the first transistor is coupled to the control end;
a gate of the second transistor is coupled to the data line, a first electrode of the second transistor is coupled to the control voltage end, and a second electrode of the second transistor is coupled to the control end.

11. The pixel circuit according to claim 10, wherein the first transistor is a P-type transistor and the second transistor is an N-type transistor; or
the first transistor is an N-type transistor, and the second transistor is a P-type transistor.

12. The pixel circuit according to claim 5, wherein the control voltage end is a first voltage end or a light-emitting control end.

13. The pixel circuit according to claim 6, wherein the data-writing control circuit comprises a first transistor;
a gate of the first transistor is electrically connected to the control node, a first electrode of the first transistor is electrically connected to the scanning end, and a second electrode of the first transistor is electrically connected to the control end.

14. The pixel circuit according to claim 7, further comprising a first light-emitting control circuit, a second light-emitting control circuit, an energy storage circuit and a first initialization circuit;
the first light-emitting control circuit is coupled to a light-emitting control end, a first voltage line and the first end of the driving circuit, and is configured to control the connection or disconnection between the first voltage line and the first end of the driving circuit under a control of the light-emitting control signal provided by the light-emitting control end;
the second light-emitting control circuit is coupled to the light-emitting control end, a second end of the driving circuit and the first electrode of the light-emitting element, and is configured to control the connection or disconnection between the second end of the driving circuit and the first electrode of the light-emitting element under the control of the light-emitting control signal;
the energy storage circuit is coupled to the control end of the driving circuit and is configured to maintain the potential of the control end of the driving circuit;
the first initialization circuit is coupled to the first reset end, a first initialization voltage end and the control end of the driving circuit, and is configured to write a first initialization voltage provided by the first initialization voltage end into the control end of the driving circuit under a control of a first reset signal provided by the first reset end;
a second electrode of the light-emitting element is coupled to a second voltage line;
the driving circuit is configured to generate a driving current for driving the light-emitting element under the control of the potential of the control end.

15. The pixel circuit according to claim 14, further comprising a second initialization circuit;
the second initialization circuit is coupled to the second reset end, a second initialization voltage end and the first electrode of the light-emitting element, and is configured to write a second initialization voltage provided by the second initialization voltage end into the first electrode of the light-emitting element under a control of a second reset signal provided by the second reset end.

16. The pixel circuit according to claim 14, wherein the driving circuit comprises a third transistor, the data-writing circuit comprises a fourth transistor, the first light-emitting control circuit comprises a fifth transistor, the second light-emitting control circuit comprises a sixth transistor, the compensation control circuit comprises a seventh transistor, the first initialization circuit comprises an eighth transistor, and the energy storage circuit comprises a storage capacitor;
a gate of the third transistor is coupled to the control end of the driving circuit, a first electrode of the third transistor is coupled to the first end of the driving circuit, and a second electrode of the third transistor is coupled to the second end of the driving circuit;
a gate of the fourth transistor is coupled to the control end, a first electrode of the fourth transistor is coupled to the data line, and a second electrode of the fourth transistor is coupled to the first electrode of the third transistor;
a gate of the fifth transistor is coupled to the light-emitting control end, a first electrode of the fifth transistor is coupled to the first voltage line, and a second electrode of the fifth transistor is coupled to the first electrode of the third transistor;
a gate of the sixth transistor is coupled to the light-emitting control end, a first electrode of the sixth transistor is coupled to the second electrode of the third transistor, and a second electrode of the sixth transistor is coupled to the first electrode of the light-emitting element;
a gate of the seventh transistor is coupled to the control end, a first electrode of the seventh transistor is coupled to the gate of the third transistor, and a second electrode of the seventh transistor is coupled to the second electrode of the third transistor;
a gate of the eighth transistor is coupled to the first reset end, a first electrode of the eighth transistor is coupled to the first initialization voltage end, and a second electrode of the eighth transistor is coupled to the gate of the third transistor;
a first end of the storage capacitor is electrically connected to the gate of the third transistor, and a second end of the storage capacitor is electrically connected to the first voltage line.

17. The pixel circuit according to claim 15, wherein the second initialization circuit comprises a ninth transistor;
a gate of the ninth transistor is coupled to the second reset end, a first electrode of the ninth transistor is coupled to the second initialization voltage end, and a second electrode of the ninth transistor is coupled to the first electrode of the light-emitting element.

18. A display substrate, comprising the pixel circuit according to claim 1.

19. A display device, comprising the display substrate according to claim 18.

20. A display driving method, applied to the display device according to claim 19, wherein the display area of the display device comprises a low refresh rate display area; the low refresh rate display area corresponds to at least one corresponding non-refresh display period; the at least one non-refresh display period is comprised in the display time; the display driving method comprises:
in the low refresh rate display area, during the data-writing phase included in the non-refresh display period, the data-writing control circuit controlling the data-writing circuit to stop writing the data voltage into the first end of the driving circuit under the control of the control signal.

21. (canceled)

22. (canceled)
